(19) United States
(12) Patent Application Publication
(10) Pub. No.: US 2006/0000138 A1
(43) Pub. Date: Jan. 5, 2006

(54) Casting spinner lure

(76) Inventor: Richard Allen Druk, West Bountiful, UT (US)

Correspondence Address: RICHARD A. DRUK, 1811 N. 600 W., WEST BOUNTIFUL, UT, 84087, US

(21) Appl. No.: 11/187,148

(22) Filed: Sep. 12, 2005

Related U.S. Application Data
(62) Division of application No. 10/627,040, filed on Jul. 25, 2003.

(51) Int. Cl. A01K 85/00; A01K 85/01

(52) U.S. Cl. 43/42.09; 43/42.19; 43/42.06

(57) ABSTRACT

A casting spinner lure having a screw-like connector, retainer, and leader line with attached hook or artificial bait. The screw-like connector and retainer supports the leader line to minimize the hook or artificial bait from becoming tangled with the fishing line or lure itself The screw-like connector permits exchangeability of the hook or artificial bait.

### CROSS REFERENCE TO RELATED APPLICATIONS

Not Applicable

### FEDERALLY SPONSORED RESEARCH

Not Applicable

### DESCRIPTION OF ATTACHED APPENDIX

Not Applicable

### FIELD OF THE INVENTION

The invention relates to sport fishing using artificial spinner lures, and more particularly, to a casting spinner lure.

### BACKGROUND OF THE INVENTION

In the prior art spinner lures were commonly shown with one or two blades, beads, clevis(es), a straight flexible wire shaft where the hook or artificial bait would be attached and either with or without a casting weight. To connect the hook or artificial bait, such as an artificial fly pattern to the eye of the wire shaft, typical connecting devices such as link(s), snap(s), snap-swivels(s), swivels or spilt-ring(s) can be used. Examples of the companies that manufacture these spinner lures are Mepps, Worden's and Blue Fox. For the majority of these spinner lures it is difficult to change artificial baits easily.

Normally, anglers will just use another spinner lure which adds to the cost of their fishing enjoyment.

Predatory fish are attracted to a spinner lure primarily by its spinning blade(s) and coloration. They will the take or strike the spinner lure because of instinctive traits of hunger, anger and in some fish species curiosity. As the spinner lure moves through the water column it does not have substantial wobbling action that would also help stimulate these instinctive traits.

It is well know that by increasing the distance the artificial bait from the lure itself by a length of flexible leader line increases substantially the probability that a predatory fish will strike or take the artificial bait. This is commonly accomplished by trolling a device with rotating blades with attached extended leader and bait or artificial bait and not by casting and retrieving.

One significant problem that occurs when an angler attempts to cast with a spinning lure or device with leader line or extended flexible leader is that it becomes twisted or tangled with the fishing line or spinning lure itself This is primarlly caused by the length of the flexible leader and movement or swinging of the connector itself. By not having a casting spinner lure with an extended leader is frustrating to anglers who are fishing from a riverbank, shoreline, or non-trolling watercraft.

What is needed is a casting spinner lure with nutate or wobbly action, an extended flexible leader and a screw-like connector that permits exchangeability of the leader, hook or artificial bait. A retainer that supports the extended flexible leader, along with the connector that would not swing or twist would minimize the tangling of the hook or artificial bait with the casting spinner lure.

### DESCRIPTION OF THE PRIOR ART

U.S. Pat. No. 853,972 issued to E. A. Grout on May 21, 1907 discloses an Artificial Bait or trolling lure with an extended flexible leader. No retainer is disclosed and this is not a weighted casting spinner lure.

U.S. Pat. No. 1,515,849 issued to L. J. Eppinger on Nov. 18, 1924 discloses a Casting Lure with a tubular guard serving as a keeper to where the hook is fastened to the lure. No leader line or screw-like connector is disclosed.

U.S. Pat. No. 1,713,041 issued to G. W. Fey on May 14, 1929 discloses a Fishhook Coupling Device with the hook attached directly to the lure. No leader line or screw-like connector is disclosed.

U.S. Pat. No. 2,756,478 issued to John J. Morrissey on Jul. 31, 1956 discloses a Fishline Connector Joint with a plastic protective tube. The protective tube fails to provide any means for supporting a leader line and to hold a connector attached to a fishing lure from excessive movement while casting.

U.S. Pat. No. 3,293,790 issued to D. A. Konomos on Dec. 27, 1966 discloses a Fishing Lure with a screw connector. No leader line, retainer or lure nutate motion is disclosed.

U.S. Pat. No. 3,760,468 issued to Creath W. Linville on Sep. 25, 1973 discloses a fishing connector. The connector disclosed is not a screw-like connector.

U.S. Pat. No. 3,987,576 issued to James W. Strader on Oct. 26, 1976 discloses a Fishing Lure with the hook attached directly to the lure. No leader line, connector or retainer is disclosed.

U.S. Pat. No. 4,024,608 issued to Robert A. Brewer on May 24, 1977 discloses a Function-Separating Connector with a sleeve. The sleeve fails to provide any means for supporting a leader line and is unlike the retainer in the present invention.

U.S. Pat. No. 4,208,824 issued to James D. Maxwell on Jun. 24, 1980 discloses a Fishing Lure where the hook is attached by means of a spilt-ring connector. No leader line, screw-like connector or retainer is disclosed.

U.S. Pat. No. 5,228,875 issued to Ralph M. Swenson, Sr., on Jul. 20, 1993 discloses a Quick Connect Electrical Connector. The connector in the present invention fails to provide any means for supporting or attaching a leader line.

U.S. Pat. No. 5,634,290 issued to Floyd H. Johnson on Jun. 3, 1997 discloses a Device And Method For Making A Fishing Lure with a retainer. The disclosed retainer fails to provide any means for supporting a leader line and to hold a connector attached to a fishing lure from excessive movement while casting.

U.S. Pat. No. 420,418 issued to Tommy Allmon on Feb. 8, 2000 discloses a Fishing Lure with a connector. No leader line or retainer is disclosed.

U.S. Pat. No. 6,176,036 issued to Philp J. Pease on Jan. 23, 2001 discloses a Terminal Tackle. No means is disclosed for supporting a leader line and a screw-like connector is not disclosed. Moreover, the y shaped tube is unlike the retainer in the present invention.

U.S. Pat. Appl. 20010047608 submitted on Dec. 6, 2001 by Daniel S. Cox discloses a Fishing Lure With Dual Wing Compound Angle Spinning Blade. No retainer or leader line is disclosed.

None of the above noted patents, taken either singly or in combination, are seen to disclose the specific arrangement of concepts disclosed by the present invention.

### SUMMARY OF THE INVENTION

By the present invention, an improved casting spinner lure is disclosed.

Accordingly, one of the objects and advantages of the present invention is a screw-like connector that permits exchangeability of the leader line, hook and artificial bait. Furthermore the connector does not swing or twist while casting and retrieving.

Another of the objects of the present invention includes leader line or extended flexible leader, which is attached to the externally or male threaded element of the screw-like connector. At the trailing end of the extended flexible leader line is attached a hook or artificial bait.

Yet another of the objects of the present invention is a tubular retainer that would slide over the flexible leader line and partially onto the screw-like connector. The retainer supports the flexible leader line from undo bending or swinging while casting the spinning lure. Thus, the retainer prevents, along with the screw-like connector, the extended flexible leader line with attached hook or artificial bait from becoming tangled or twisted with the lure itself or fishing line when casting.

With a casting spinner lure not having a screw-like connector, the tubular retainer can also hold a typical connector such as link(s), snap(s), snap-swivels(s), swivels and spilt-ring(s) in somewhat of a locked position and therefore prevent the connector from bending or swinging while casting the spinning lure which will prevent the attached flexible leader and hook from becoming tangled.

A further object of the present invention is the tubular retainer has circular holes near the end that covers the extended flexible leader line where fish attracting scent can be placed.

A final object of the present invention, which in our belief is that the screw-like connector that is, attached pivotably, tubular retainer, and extended flexible leader, when being pulled through the water provides the improved casting spinner lure a nutate or wobbling action. Even so this is our belief we do not want to be bound by it. This wobbly action then imparts to predatory fish a realistic movement of something alive, which helps to provoke a strike of the bait or artificial bait.

Further objects and advantages of the present invention will become apparent from a consideration of the drawings and ensuing description.

### BRIEF DESCRIPTION OF THE DRAWINGS

FIG. 1 depicts a perspective view of one preferred embodiment of the invention.

FIG. 2 depicts an exploded view of one preferred embodiment of the screw-like connector.

FIG. 3 depicts an exploded view of an alternative embodiment of the screw-like connector.

FIG. 4 depicts a perspective view of an alternative embodiment of the invention without a screw-like connector.

### REFERENCE NUMBERALS IN DRAWINGS

| | |
|---|---|
| 10 | casting spinner lure |
| 12 | flexible wire shaft |
| 12a | flexible wire shaft first end eye or loop |
| 12b | flexible wire shaft second end eye or loop |
| 14 | knots (flexible wire shaft) |
| 16 | clevis |
| 18 | spinner blade |
| 20 | bead |
| 22 | weight |
| 24 | connector (screw-like) |
| 24a | internal or female threaded |
| | (connector) end |
| 24b | external or male threaded (connector) end |
| 24c | connector chamber |
| 24d | splines or gripping members (female end) |
| 24e | splines or gripping members (male end) |
| 26 | rigid wire shaft |
| 26a | rigid wire shaft first end eye or loop |
| 26b | rigid wire shaft second end eye or loop |
| 28 | tubular retainer |
| 30 | circular holes |
| 32 | leader line |
| 32a | leading end (leader line) |
| 32b | trailing end (leader line) |
| 34 | split ring (connector) |
| 36 | tapered tubular retainer |
| 38 | fishing hook |

### DETAILED DESCRIPTION OF SOME PREFERRED EMBODIMENTS

The essence of the casting spinner lure is related to a connector with internal or female and external or male threaded elements or ends which are mated together or a screw-like connector to improve exchangeability of different forms of bait or artificial baits. A retainer to support the leader line and fishing hook or artificial bait while casting and retrieving. Thus, preventing the leader line and fishing hook from becoming tangled with the lure itself The screw-like connector, leader line and retainer provide a wobbly movement to the overall lure when in use.

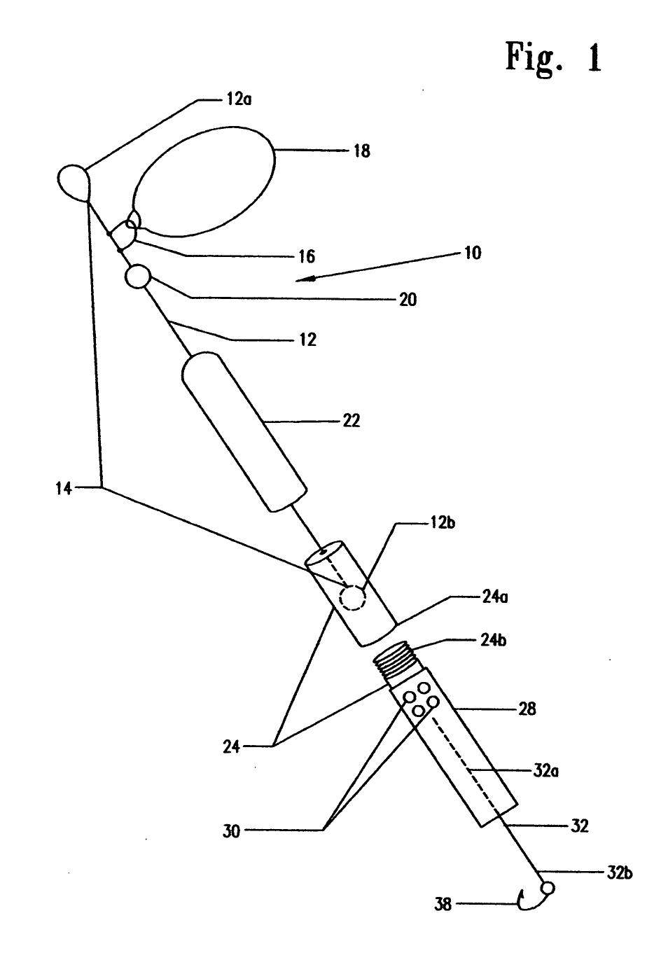

Referring to FIG. 1, a perspective view of one preferred embodiment of the invention is shown. The casting spinner lure 10 has a longitudinal axis along which a flexible elongated wire shaft 12 runs, forming an eye or loop 12a at the first end and another at the second end 12b. Knots 14 secure the loops. The metal or plastic screw-like connector 24 is affixed above the second end eye 12b through an aperture. Disposed on the connector 24 is an internal or female threaded end 24a and a male or external threaded end 24b, which are mated together for attaching leader line 32, fishing hook 38, or artificial bait (not shown). A plastic or rubber tubular retainer 28 is contiguous to the connector 24 and has a predetermined length, and opposite leading and trailing ends. It is preferred that the retainer 28 has a cylindrical and uniform inside diameter of 4 mm along its length of 2 cm. The retainer 28 as an axial bore between the ends of a diameter enabling the retainer 28 to be slid partially onto, approximately 3 mm, and then off the connector 24 in response to application of bodily pulling force on the retainer 28. Circular holes 30 are disposed on the retainer 28 for the placement of fish attracting scent. The retainer 28 surrounds the leading end (leader line) 32a, of approximately 18 mm, of the leader line 32 total length of approximately 5 cm. The hook 38 or artificial bait, such as an artificial fly pattern (not shown) is attached to the trailing end (leader line) 32b by a typical fishing knot such as an improved clinch knot (not shown). The lure 10 includes a conventional rotatable spinner blade 18, which is attached to the wire shaft 12 by a conventional clevis 16. Below the spinner blade 18, a generally round bead 20 which is movable along the flexible wire shaft 12, and a body or weight 22 is provided. The body or weight 22 is for casting and keeping the lure 10 submerged in water while in use. Each of the clevis 16, bead 20 and weight 22 have an aperture through which the flexible wire 12 projects. The spinner blade 18 spins about the longitudinal axis of the wire as it is pulled through the water.

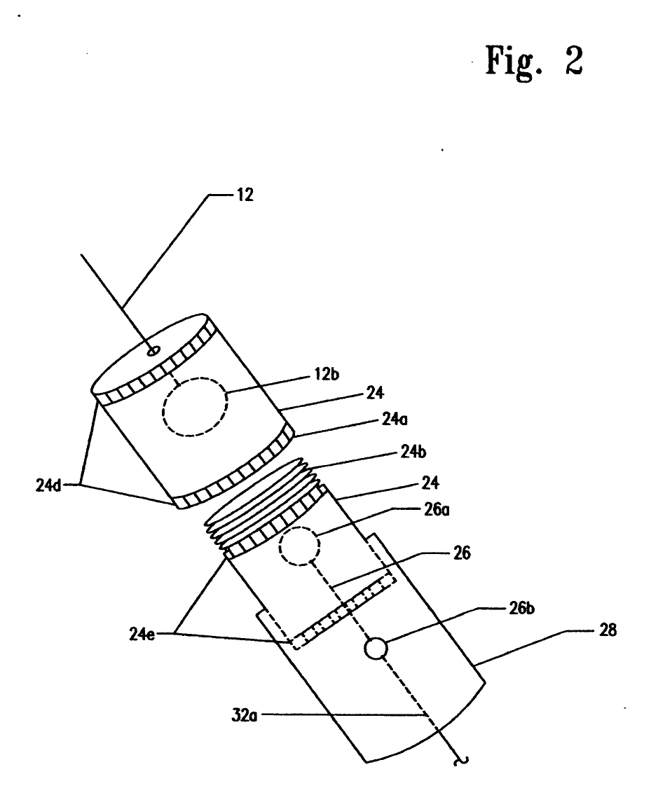

Referring to FIG. 2, an exploded view of the screw-like connector is depicted. The screw-like connector 24 has generally a cylinder shape that includes a female or internal threaded connector end 24a and a male or external threaded connector end 24b and their opposite end being oblate. The connector 24 with a length 1 cm has two apertures through which the flexible wire shaft 12 and the rigid wire shaft 26 projects. The female threaded connector end 24a is oriented pivotably above the flexible wire shaft second end eye 12b and is secured by knot (not shown). This enables the connector 24 to rotate and wobble. Along with the retainer 28 and connector 24, helps to provide the casting spinner lure with a nutate or wobbly motion when the casting spinner lure is pulled through the water and prevents the connector 24 from breaking off when a fish strikes the hook 38 or artificial bait. Since both female and male connector ends 24a and 24b are threaded they are attached or connected together by exerting a twisting motion. There are circumferentially spaced splines or raised gripping members 24d and 24e disposed on the male and female connector ends 24a and 24b. This enables an individual to grip the connector ends, especially when they are wet, to ensure the connector 24 is tightly fastened and to hold the retainer 28 in place. The connector 24 has a longitudinal axis along which the rigid connector wire shaft 26 runs through the aperture of the male threaded connector end 24b forming an eye or loop 26a at the first end an another at the second end 26b. Knots secure the loops (not shown). The leading end (leader line) 32a is attached to the second end eye 26b.

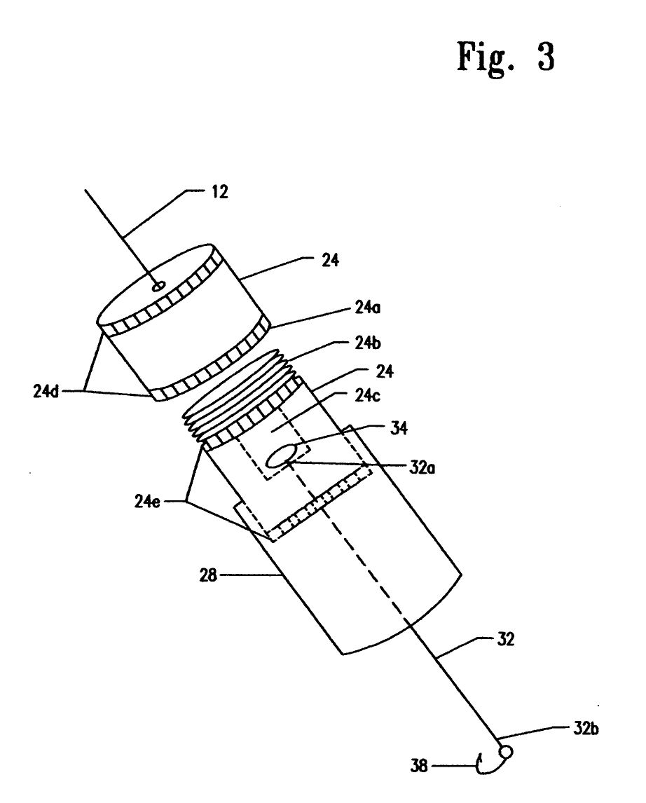

Referring to FIG. 3, an exploded view of an alternative embodiment of the screw-like connector is depicted. The screw-like connector 24 has a generally a cylinder shape that includes a female threaded connector end 24a and a male threaded connector end 24b. The connector 24 has two apertures where the flexible wire shaft 12 and the leading end (leader line) 32a of the leader line 32 projects. The leading end 32a is affixed to a split ring (connector) 34, which is disposed inside the connector chamber 24c of the male connector end 24b. The female threaded connector end 24a is oriented pivotably on the flexible wire shaft 12. Circular splines 24d and 24e or raised gripping members are disposed on the male and female connector ends 24a and 24b. Affixed to the trailing end (leader line) 32b is the hook 38. The retainer 28 slides partially onto the male threaded connector end 24b.

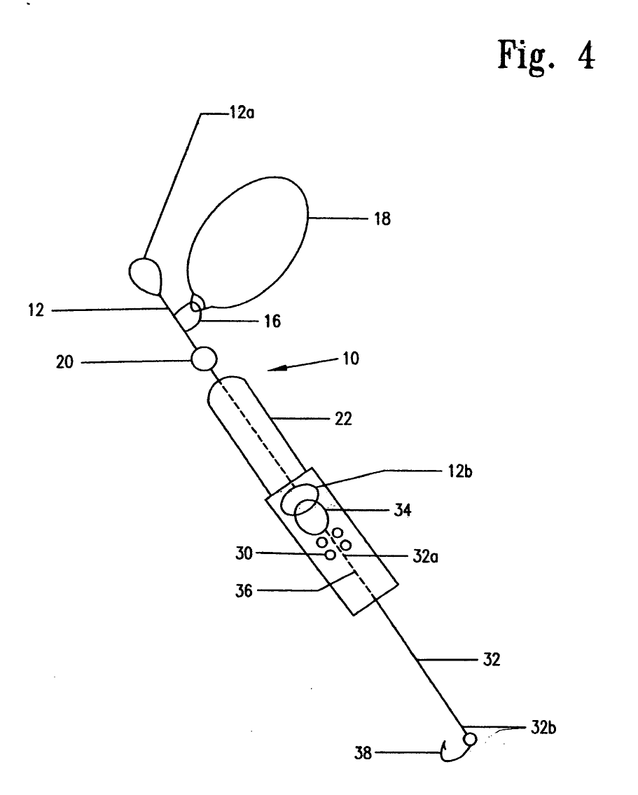

Referring to FIG. 4, a perspective view of an alternative embodiment of the invention without the screw-like connector is depicted. It includes a flexible wire shaft 12 oriented along the longitudinal axis of the lure 10, forming an eye or loop 12a at the first end and another at the second end 12b. Affixed to the eye 12b is a spilt ring (connector) 34. Attached to the spilt ring 34 is leading end (leader line) 32a. Attached to the trailing end (leader line) 32b is the hook 38. A plastic or rubber tapered tubular retainer 36 slides over the leader line 32, spilt ring 34 and eye 12b. The retainer 36 with a plurality of circular holes 30, where fish attracting scent can be placed, substantially supports the leader line 32 attached to the spilt ring 34 and engages the spilt ring 34 and fishing lure with frictional force sufficient to press against the spilt ring 34 and fishing lure as to hold or to lock the spilt ring 34 in position. This then prevents the spilt ring 34 from a swinging or twisting motion when casting the lure and along with the retainer 36 supporting the leader line 32 minimizes the attached hook 38 or artificial bait (not shown) from becoming tangled with the fishing lure or fishing line (not shown). The retainer 36 has a predetermined length, opposite leading and trailing ends, and an axial bore between the ends of a diameter enabling the retainer 36 to be slid onto and off the leader line 32, spilt ring 34 and fishing lure in response to application of bodily pulling force on the retainer 36. A conventional spinner blade 18 is affixed to the wire shaft 12 by a clevis 16 and is atop a round bead 20 and a weight 22. It can also be appreciated that a connecting member to the flexible wire shaft 12 and the leading end (leader line) 32a can be conventional fishing connectors, commonly know as, link(s), snaps(s), snap-swivel(s), or swivel(s) (all not shown) or a typical snap-like connector (not shown) that would have a first end and a second end similar to the screw-like connector.

While the tubular retainer 28 shown in FIG. 1 is preferred, it is to be understood that other retainer designs, such as the tapered tubular retainer 36 shown in FIG. 4 are contemplated, provided they support the leader line, fishing hook or artificial bait to minimize the tangling with the fishing lure or line while casting and retrieving.

While the description above contains many specificities, these should not be construed as limitations on the scope of the invention, but as merely providing illustration of some of the presently preferred embodiments of this invention. Therefore, the scope of the invention should be determined by the appended claims and their legal equivalents, rather than the examples given in the true spirit and scope of the invention.

What is claimed is:

1. A casting spinner lure comprising:
a flexible wire shaft with a longitudinal axis, a first end and a second end, an eye or loop located at said flexible wire shaft first and second end;
a spinner blade affixed to said flexible wire shaft by means of a clevis below said flexible wire shaft first end;
a generally round bead connected and movable along said flexible wire shaft and disposed below said spinner blade;
a weighted member located around said flexible wire shaft below said bead and having a mass chosen to serve as a weight for casting and keeping said casting spinner lure submerged in water while in use;
a connector affixed pivotably above said flexible wire shaft second end eye with internal or female and external or male threaded elements which are mated together as a means for attaching leader line, fishing hook, and artificial bait to said spinner casting lure; and
a retainer contiguous to said connector and disposed thereof a plurality of circular holes, whereby said retainer slides onto and off said connector and said retainer substantially supports said leader line and said fishing hook or said artificial bait, thereby preventing said leader line and said fishing hook or said artificial bait from becoming tangled with said casting spinner lure or fishing line while casting or retrieving.

2. The casting spinner lure in claim 1 wherein said connector is made of metal and has generally a cylinder shape with oblate ends.

3. The casting spinner lure in claim 1 wherein said connector has an aperture therein through which said flexible wire shaft projects.

4. The casting spinner lure in claim 1 further including said connector has an aperture therein through which a rigid wire shaft projects from said external threaded element having a longitudinal axis, a first end and a second end, an eye or loop located on said rigid wire shaft first and second end.

5. The connector in claim 4 wherein said leader line is affixed to said rigid wire shaft second end eye.

6. The casting spinner lure in claim 1 further including said connector has a spilt ring disposed inside a chamber of said external threaded element as a means for affixing said leader line to said connector, whereby said spilt ring replaces said rigid wire shaft.

7. The casting spinner lure in claim 1 wherein there are circumferentially spaced raised splines or gripping members disposed on said connector.

8. The casting spinner lure in claim 1 wherein said retainer having opposite leading and trailing ends and an axial bore between said ends of a diameter enabling said retainer to be slid onto and off said connector and said leader line.

9. The casting spinner lure in claim 1 wherein said retainer engages said connector with frictional force sufficient to press against said connector and enabling said retainer to be slid onto and off said connector in response to application of bodily pulling force on said retainer.

10. The casting spinner lure in claim 1 wherein said retainer has an outer cylindrical surface of generally uniform diameter.

11. The casting spinner lure in claim 1 wherein said retainer has a predetermined length, a tubular shape, said circular holes for placement of fish attracting scent, surrounds the leading end of said leader line and is made of plastic.

12. The casting spinner lure in claim 1 wherein said connector is affixed pivotably above said flexible wire shaft second end eye, whereby along with said retainer provides said casting spinner lure with a nutate or wobbly motion as said casting spinner lure is pulled through the water and prevents said connector from breaking off when a fish strikes said fishing hook or said artificial bait.

13. A terminal fishing tackle for minimizing tangling of leader line comprising:
a retainer with a plurality of circular holes, whereby fish attracting scent can be placed, as means for substantially supporting said leader line and fishing hook or artificial bait, attached to a connector and said retainer engaging said connector and fishing lure with frictional force sufficient to press against said connector and said fishing lure as to hold or to lock said connector in position, whereby minimizing said leader line, said fishing hook or said artificial bait, from becoming tangled with said fishing lure or fishing line while casting and retrieving.

14. A terminal fishing tackle for minimizing tangling of leader line as claimed in claim 13 wherein said retainer has opposite leading and trailing ends and an axial bore between said ends of a diameter enabling said retainer to be slid onto and off said leader line, said connector and said fishing lure in response to application of bodily pulling force on said retainer.

15. A terminal fishing tackle for minimizing tangling of leader line as claimed in claim 13 wherein said retainer engages said fishing lure where said leader line, said fishing hook or said artificial bait can be attached, with frictional force sufficient to press against said fishing lure as to hold said retainer in place.

16. A terminal fishing tackle for minimizing tangling of leader line as claimed in claim 13 wherein said retainer holds or as to lock in connecting members such as, commonly known as, link(s), snaps(s), snap-swivel(s), spilt rings(s) or swivel(s), whereby minimizing said members from bending or swinging and thus, minimizes said leader line, said fishing hook or said artificial bait from becoming tangled with said fishing lure or said fishing line when casting.

17. A terminal fishing tackle for minimizing tangling of leader line as claimed in claim 13 wherein said retainer has a predetermined length, surrounds the leading end of said leader line and is made of plastic.

18. A terminal fishing tackle for minimizing tangling of leader line as claimed in claim 13 wherein said retainer has an outer cylindrical surface of generally uniform diameter.
